(19) United States
(12) Patent Application Publication
(10) Pub. No.: US 2024/0177004 A1
(43) Pub. Date: May 30, 2024

(54) METHOD FOR TRAINING AN ARTIFICIAL NEURAL NETWORK

(71) Applicant: Robert Bosch GmbH, Stuttgart (DE)

(72) Inventor: Lukas Enderich, Berlin (DE)

(21) Appl. No.: 18/519,566

(22) Filed: Nov. 27, 2023

(30) Foreign Application Priority Data
Nov. 30, 2022 (DE) 10 2022 212 902.4

(51) Int. Cl. G06N 3/08

(52) U.S. Cl. CPC G06N 3/08

(57) ABSTRACT

A method for training an artificial neural network. The method includes the following steps: providing training data for training the artificial neural network; detecting at least one specification regarding available resources; ascertaining a cost function that, in addition to an actual learning task, also takes into account the at least one specification regarding available resources; and training the artificial neural network on the basis of the provided training data using the ascertained cost function.

### CROSS REFERENCE

The present application claims the benefit under 35 U.S.C. § 119 of German Patent Application No. DE 10 2022 212 902.4 filed on Nov. 30, 2022, which is expressly incorporated herein by reference in its entirety.

### FIELD

The present invention relates to a method for training an artificial neural network that is designed such that, in addition to the actual learning task, a complexity of the artificial neural network can at the same time also be reduced to a desired target variable during training.

### BACKGROUND INFORMATION

Machine learning algorithms are based on using statistical methods to train a data processing system in such a way that it can perform a particular task without it being originally programmed explicitly for this purpose. The goal of machine learning is to construct algorithms that can learn and make predictions from data. These algorithms create mathematical models with which data can be classified, for example.

An example of such machine learning algorithms are artificial neural networks. Artificial neural networks are patterned after biological neurons and allow for the learning of an unknown system behavior from existing training data and subsequent application of the learned system behavior to unknown input variables. The neural network consists of layers having idealized neurons, which are connected to one another in different ways in accordance with a topology of the network. The first layer, which is also referred to as an input layer, detects and transmits input values, the number of neurons in the input layer corresponding to the number of input signals to be processed. The last layer is also referred to as an output layer and has exactly as many neurons as outputs or output values to be provided. Between the input layer and the output layer there is also at least one intermediate layer, which is often also referred to as a hidden layer, the number of intermediate layers and the number of neurons in these layers usually being dependent on the specific problem to be solved by the neural network. Such artificial neural networks are used in particular in the field of image processing, for example for processing image data when controlling autonomously driving motor vehicles.

However, it proves to be disadvantageous here that, for example for safety reasons, the largest possible artificial neural networks are to be trained, or as many different training data and/or computing operations as possible are to be taken into account during training of a corresponding artificial neural network, whereas conventional data processing systems, for example mobile devices or embedded systems, increasingly have only limited resources, for example memory and/or computing capacities. These limited resources mean in particular that the complexity, that is to say the depth or ability to solve problems and questions exactly, of an artificial neural network to be executed on the corresponding data processing system must be limited accordingly.

A method for producing a plurality of device-specific artificial neural networks is described in PCT Patent Application No. WO 2020/193481 A1, wherein in a first iteration, depending on a general network architecture comprising a plurality of neurons, neurons of a device-specific network architecture are stochastically determined for one of the plurality of device-specific artificial neural networks, wherein a training data point for an output of the artificial neural network is propagated forwards by the neurons of the device-specific network architecture, wherein for a second iteration, the weights of the neurons of the device-specific network architecture are determined by backpropagation depending on the output, and wherein the weights of the other neurons are maintained for the second iteration.

An object of the present invention is to provide a method for training an artificial neural network that takes into account specifications regarding available resources but with which an artificial neural network can at the same time also be trained with optimal performance.

The object may be achieved by a method for training an artificial neural network according to features of the present invention.

The object also may be achieved by a system for training an artificial neural network according to features of the present invention.

### SUMMARY

According to one example embodiment of the present invention, this object may be achieved by a method for training an artificial neural network, wherein the method comprises providing training data for training the artificial neural network, detecting at least one specification regarding available resources, ascertaining a cost function that, in addition to an actual learning task, also takes into account the at least one specification regarding available resources, and training the artificial neural network on the basis of the provided training data using the ascertained cost function.

Specification regarding available resources or complexity metrics is understood to mean specifications regarding hardware capacities, for example memory and/or processor capacities, available on a target device on which the trained artificial neural network is to be executed after the training.

Cost function or loss is further understood to mean a loss or an error between ascertained output values of the artificial neural network and reference values or labeled comparative values, for example corresponding actual conditions or actually measured data.

A cost function that, in addition to an actual learning task, that is to say specifications relating to the corresponding application, also takes into account the at least one specification regarding available resources, is understood here to mean a cost function that, in addition to the actual learning task and errors between ascertained output values of the artificial neural network and reference values, also describes deviations between current model complexities, or a current complexity of the artificial neural network, and a desired target complexity.

According to an example embodiment of the present invention, an artificial neural network having a high performance is thus trained, since an underlying learning task is also taken into account, but at the same time the complexity of the trained artificial neural network is also reduced to the extent that upper limits for complexity metrics based on corresponding hardware capacities can be complied with. In addition, the method can be expanded simply to further specifications or further complexity metrics and can be integrated simply in conventional training methods for training an artificial neural network.

Overall, according to the present invention, a method for training an artificial neural network is thus specified that takes into account specifications regarding available resources but with which an artificial neural network can at the same time also be trained with optimal performance.

In one example embodiment of the present invention, the step of training the artificial neural network comprises applying a pruning method and/or a quantization method during training of the artificial neural network.

A pruning method is understood to mean a method for thinning out a neural network, or a method for reducing a number of connections, neurons and/or filters of an artificial neural network.

A quantization method is further understood to mean a method for reducing a resolution or step size or bit size of an artificial neural network.

The application of a pruning method and/or a quantization method has the advantage that the resources available on the target device can automatically be distributed to the individual layers of the artificial neural network, so that a corresponding desired target complexity can be achieved. In addition, pruning methods and quantization methods are conventional, and therefore they can be implemented or applied here without the need for complex and resource-intensive adaptations.

According to an example embodiment of the present invention, the at least one specification regarding available resources can furthermore contain one or more of a specification regarding available memory capacities, a specification regarding an available bandwidth, or a specification regarding a possible number of bit operations.

In this case, specifications regarding available memory capacities are understood to mean specifications or information about a maximum amount of data that can be stored on a corresponding target device.

Specifications regarding an available bandwidth are further understood to mean specifications or information about a maximum data transmission rate available on a corresponding target device.

Specifications regarding a possible number of bit operations are further understood to mean specifications or information about a number of operations or assignments executable on a corresponding target device.

Overall, the at least one specification regarding available resources can thus contain specifications or information about all resources that relate to the architecture or execution of the artificial neural network and are available on a corresponding target device on which the trained artificial neural network is to be executed.

However, the case in which the at least one specification regarding available resources contains one or more of a specification regarding available memory capacities, a specification regarding an available bandwidth, or a specification regarding a possible number of bit operations, is only one possible embodiment. Rather, the at least one specification regarding available resources can also contain specifications or information regarding further resources of a corresponding target device, for example general information about further modules or hardware components available on the target device, for example information about a type of hard disk used.

According to an example embodiment of the present invention, the training data can furthermore contain sensor data, in particular in connection with the corresponding learning task or sensor data detected with regard to the corresponding learning task.

A sensor, which is also referred to as a (measuring) probe, is a technical component that can detect certain physical or chemical properties and/or the material nature of its surroundings qualitatively or quantitatively as a measured variable.

Conditions outside the actual data processing system on which the artificial neural network is trained can thus be detected in a simple manner and taken into account during training of the artificial neural network.

With a further example embodiment of the present invention, a method for classifying image data is also specified, wherein image data are classified using an artificial neural network that is trained to classify image data, and wherein the artificial neural network has been trained using a method described above for training an artificial neural network.

In particular, the method can be used to classify image data, in particular digital image data, on the basis of low-level features, for example edges or pixel attributes. In this case, an image processing algorithm can furthermore be used to analyze a classification result which is focused on corresponding low-level features.

According to an example embodiment of the present invention, a method for classifying image data is thus specified, which is based on an artificial neural network trained by a method for training an artificial neural network that takes into account specifications regarding available resources but with which an artificial neural network can at the same time also be trained with optimal performance. An artificial neural network having a high performance is trained, since an underlying learning task is also taken into account, but at the same time the complexity of the trained artificial neural network is also reduced to the extent that upper limits for complexity metrics based on corresponding hardware capacities can be complied with. In addition, the method for training the artificial neural network can be expanded simply to further specifications or further complexity metrics and can be integrated simply in conventional training methods for training an artificial neural network.

With a further example embodiment of the present invention, a system for training an artificial neural network is also specified, wherein the system has a providing unit that is designed to provide training data for training the artificial neural network, a detection unit that is designed to detect at least one specification regarding available resources, an ascertaining unit that is designed to ascertain a cost function that, in addition to an actual learning task, also takes into account the at least one specification regarding available resources, and a training unit that is designed to train the artificial neural network on the basis of the provided training data using the ascertained cost function.

According to an example embodiment of the present invention, a system for training an artificial neural network that takes into account specifications regarding available resources but with which an artificial neural network can at the same time also be trained with optimal performance is thus specified. An artificial neural network having a high performance is trained, since an underlying learning task is also taken into account, but at the same time the complexity of the trained artificial neural network is also reduced to the extent that upper limits for complexity metrics based on corresponding hardware capacities can be complied with. In addition, the system can be expanded simply to further specifications or further complexity metrics and can be integrated simply in conventional training methods for training an artificial neural network.

In one example embodiment of the present invention, the training unit is further designed to apply a pruning method and/or a quantization method during training of the artificial neural network. The application of a pruning method and/or a quantization method has the advantage that the resources available on a corresponding target device can automatically be distributed to the individual layers of the artificial neural network, so that a corresponding desired target complexity can be achieved. In addition, pruning methods and quantization methods are convention, and therefore they can be implemented or applied here without the need for complex and resource-intensive adaptations.

According to an example embodiment of the present invention, the at least one specification regarding available resources can furthermore again have one or more of a specification regarding available memory capacities, a specification regarding an available bandwidth, or a specification regarding a possible number of bit operations. Overall, the at least one specification regarding available resources can thus contain specifications or information about all resources that relate to the architecture or execution of the artificial neural network and are available on a corresponding target device on which the trained artificial neural network is to be executed.

However, the case in which the at least one specification regarding available resources contains one or more of a specification regarding available memory capacities, a specification regarding an available bandwidth, or a specification regarding a possible number of bit operations, is only one possible embodiment. Rather, the at least one specification regarding available resources can also contain specifications or information regarding further resources of a corresponding target device, for example general information about further modules or hardware components available on the target device, for example information about a type of hard disk used.

According to an example The training data can furthermore again contain sensor data, in particular in connection with the corresponding learning task or sensor data detected with regard to the corresponding learning task. Conditions outside the actual data processing system on which the artificial neural network is trained can thus be detected in a simple manner and taken into account during training of the artificial neural network.

With a further embodiment of the present invention, a system for classifying image data is also specified, wherein the system is designed to classify image data using an artificial neural network that is trained to classify image data, and wherein the artificial neural network has been trained using a system described above for training an artificial neural network.

In particular, the system can be used to classify image data, in particular digital image data, on the basis of low-level features, for example edges or pixel attributes. In this case, an image processing algorithm can furthermore be used to analyze a classification result which is focused on corresponding low-level features.

According to an example embodiment of the present invention, a system for classifying image data is thus specified, which is based on an artificial neural network trained by a system for training an artificial neural network that takes into account specifications regarding available resources but with which an artificial neural network can at the same time also be trained with optimal performance. An artificial neural network having a high performance is trained, since an underlying learning task is also taken into account, but at the same time the complexity of the trained artificial neural network is also reduced to the extent that upper limits for complexity metrics based on corresponding hardware capacities can be complied with. In addition, the system for training the artificial neural network can be expanded simply to further specifications or further complexity metrics and can be integrated simply in conventional training methods for training an artificial neural network.

With a further embodiment of the present invention, a computer program is also specified, having program code for carrying out an above-described method for training an artificial neural network when the computer program is executed on a computer.

With a further embodiment of the present invention, a computer-readable data carrier is also specified, having program code of a computer program for carrying out an above-described method for training an artificial neural network when the computer program is executed on a computer.

Each of the computer program and the computer-readable data carrier has the advantage that they are designed to carry out a method for training an artificial neural network that takes into account specifications regarding available resources but with which an artificial neural network can at the same time also be trained with optimal performance. An artificial neural network having a high performance is trained, since an underlying learning task is also taken into account, but at the same time the complexity of the trained artificial neural network is also reduced to the extent that upper limits for complexity metrics based on corresponding hardware capacities can be complied with. In addition, the method can be expanded simply to further specifications or further complexity metrics and can be integrated simply in conventional training methods for training an artificial neural network.

In summary, it can be stated that the present invention specifies a method for training an artificial neural network that is designed such that, in addition to the actual learning task, a complexity of the artificial neural network can at the same time also be reduced to a desired target variable during training.

The disclosed embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate embodiments and, in connection with the description, serve to explain principles and concepts of the present invention.

Other embodiments and many of the mentioned advantages may be apparent from the figures. The illustrated elements of the figures are not necessarily shown to scale relative to one another.

FIG. 1 shows a flowchart of a method for training an artificial neural network according to example embodiments of the present invention.

FIG. 2 shows a schematic block diagram of a system for training an artificial neural network according to example embodiments of the present invention.

In the figures, identical reference signs denote identical or functionally identical elements, parts or components, unless stated otherwise.

### DETAILED DESCRIPTION OF EXAMPLE EMBODIMENTS

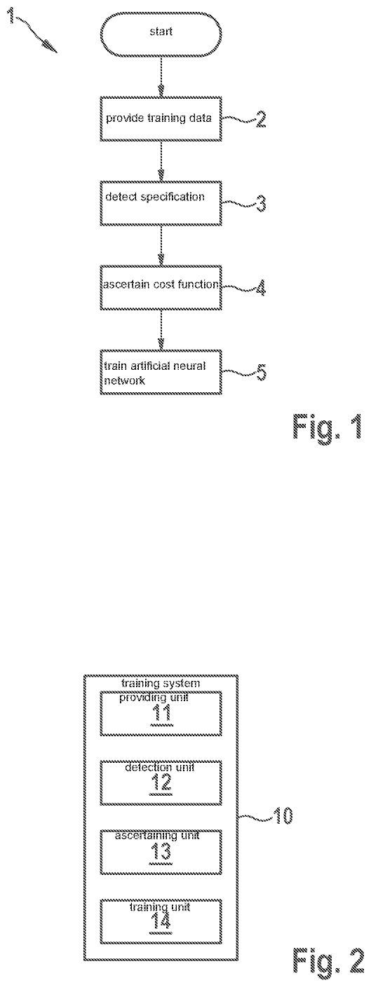

FIG. 1 shows a flowchart of a method for training an artificial neural network 1 according to embodiments of the present invention.

Artificial neural networks are used in particular in the field of image processing, for example for processing image data when controlling autonomously driving motor vehicles.

However, it proves to be disadvantageous here that, for example for safety reasons, the largest possible artificial neural networks are to be trained, or as many different training data and/or computing operations as possible are to be taken into account during training of a corresponding artificial neural network, whereas conventional data processing systems, for example mobile devices or embedded systems, increasingly have only limited resources, for example memory and/or computing capacities. These limited resources mean in particular that the complexity, that is to say the depth or ability to solve problems and questions exactly, of an artificial neural network to be executed on the corresponding data processing system must be limited accordingly.

FIG. 1 shows a method 1 comprising a step 2 of providing training data for training the artificial neural network, a step 3 of detecting at least one specification regarding available resources, a step 4 of ascertaining a cost function that, in addition to an actual learning task, also takes into account the at least one specification regarding available resources, and a step 5 of training the artificial neural network on the basis of the provided training data using the ascertained cost function.

An artificial neural network having a high performance is thus trained, since an underlying learning task is also taken into account, but at the same time the complexity of the trained artificial neural network is also reduced to the extent that upper limits for complexity metrics based on corresponding hardware capacities can be complied with. In addition, the method 1 can be expanded simply to further specifications or further complexity metrics and can be integrated simply in conventional training methods for training an artificial neural network.

Overall, a method for training an artificial neural network 1 is thus specified that takes into account specifications regarding available resources but with which an artificial neural network can at the same time also be trained with optimal performance.

In particular, an overall framework is provided for the reduction of an artificial neural network on the basis of target specifications, wherein the target specifications represent available resources on a target device on which the artificial neural network is to be executed after training, in particular a mobile device or an embedded system.

The artificial neural network can in particular be an artificial neural network trained by a deep learning method.

The at least one specification regarding available resources can also be automatically read out from a memory or a corresponding control unit. Furthermore, the at least one specification regarding available resources can however also be specified by a user via corresponding input units.

The at least one specification regarding available resources or the at least one corresponding complexity metric can also be shown in particular in the form of a variable parameter that forms the basis of a further or additional cost term in a cost function used for training the artificial neural network.

According to the embodiments of FIG. 1, step 5 of training the artificial neural network comprises applying a pruning method and a quantization method during training of the artificial neural network.

In particular, further layers relating to pruning parameters and further layers relating to quantization parameters can be inserted into or added to an already pretrained artificial neural network.

The method 1 according to the embodiments of FIG. 1 is based in particular on a combination of filter pruning and fixed-point quantization, wherein filters and neurons can be removed from the corresponding network architecture by the filter pruning, and wherein bit sizes of parameters of the artificial neural network and of activations can be reduced by the fixed-point quantization.

According to the embodiments of FIG. 1, in particular an architecture of the artificial neural network is initially expanded during training in such a way that a pruning layer is inserted behind each convolutional and fully connected layer, wherein, if the artificial neural network has normalization layers, a pruning layer is inserted in each case following a normalization layer. Each pruning layer has a trainable parameter for each channel in the respective layer. A channel is deactivated if a corresponding parameter is less than zero. All other channels remain unchanged. The trainable parameters are also used in the cost function to calculate the current values of the corresponding complexity metrics. A gradient can be calculated thereby for each of the parameters, and the network complexity can be reduced via an optimization method, for example a gradient descent method. Following the training of the artificial neural network, the pruning layers can furthermore each be convoluted into the previous or preceding layers, whereby the corresponding filters and neurons are deleted.

According to the embodiments of FIG. 1, all the rectified linear unit (ReLU) activation functions are also replaced by quantization layers, which in each case quantize the corresponding activations to a non-negative fixed-point number with a specific bit size. In addition, all the convolutional and fully connected layers are equipped with a quantization function that quantizes the corresponding parameters to fixed-point numbers during each calculation. The bit sizes of the parameters and activations are again trainable parameters, which are each used in the cost function and can be reduced by an optimization method, for example a gradient descent method.

Overall, FIG. 1 thus shows a method 1 in which an architecture of the artificial neural network and a bit size can be reduced during training of the artificial neural network on the basis of dynamic dependencies until a desired target capacity is reached.

According to the embodiments of FIG. 1, the at least one specification regarding available resources further contains a specification regarding available memory capacities, a specification regarding an available bandwidth, and a specification regarding a possible number of bit operations.

In this case, the specification regarding available memory capacities also contains a specification regarding a maximum memory requirement of the activations or activation functions of the artificial neural network.

The training data furthermore contain sensor data, in particular in connection with the corresponding learning task or sensor data detected with regard to the corresponding learning task.

A corresponding artificial neural network trained by the method 1 can be trained, for example, to classify image data, for example in the context of controlling an autonomously driving motor vehicle on the basis of objects detected in image data about an environment of a motor vehicle.

FIG. 2 shows a schematic block diagram of a system for training an artificial neural network 10 according to embodiments of the present invention.

As shown in FIG. 2, the system 10 has a providing unit 11 that is designed to provide training data for training the artificial neural network, a detection unit 12 that is designed to detect at least one specification regarding available resources, an ascertaining unit 13 that is designed to ascertain a cost function that, in addition to an actual learning task, also takes into account the at least one specification regarding available resources, and a training unit 14 that is designed to train the artificial neural network on the basis of the provided training data using the ascertained cost function.

The providing unit can in particular be a receiver that is designed to receive corresponding data, for example sensor data. The detection unit can also in particular be a receiver that is designed to read corresponding specifications from a memory and/or from a control unit, or to receive corresponding user specifications. The ascertaining unit and the training unit can also each be implemented, for example, on the basis of a code stored in a memory and executable by a processor.

According to the embodiments of FIG. 2, the training unit 14 is designed to apply a pruning method and/or a quantization method during training of the artificial neural network.

In addition, the at least one specification regarding available resources again contains a specification regarding available memory capacities, a specification regarding an available bandwidth, and a specification regarding a possible number of bit operations.

In this case, the specification regarding available memory capacities also contains a specification regarding a maximum memory requirement of the activations of the artificial neural network.

The training data also again contain sensor data, in particular in connection with the corresponding learning task or sensor data detected with regard to the corresponding learning task.

The system 10 shown is also designed to carry out an above-described method for training an artificial neural network.

What is claimed is:

1. A method for training an artificial neural network, wherein the method comprising the following steps:
providing training data for training the artificial neural network;
detecting at least one specification regarding available resources;
ascertaining a cost function that, in addition to an actual learning task, also takes into account the at least one specification regarding available resources; and
training the artificial neural network based on the provided training data using the ascertained cost function.

2. The method as recited in claim 1, wherein the step of training the artificial neural network includes applying: (i) a pruning method, and/or (ii) a quantization method during training of the artificial neural network.

3. The method as recited in claim 1, wherein the at least one specification regarding available resources contains one or more of a specification regarding available memory capacities or a specification regarding an available bandwidth or a specification regarding a possible number of bit operations.

4. The method as recited in claim 1, wherein the training data contain sensor data.

5. A method for classifying image data, the method comprising:
classifying the image data using an artificial neural network that is trained to classify image data;
wherein the artificial neural network has been trained by:
providing training data for training the artificial neural network,
detecting at least one specification regarding available resources,
ascertaining a cost function that, in addition to an actual learning task, also takes into account the at least one specification regarding available resources, and
training the artificial neural network based on the provided training data using the ascertained cost function.

6. A system for training an artificial neural network, comprising:
a providing unit configured to provide training data for training the artificial neural network;
a detection unit configured to detect at least one specification regarding available resources;
an ascertaining unit configured to ascertain a cost function that, in addition to an actual learning task, also takes into account the at least one specification regarding available resources; and
a training unit configured to train the artificial neural network based on the provided training data using the ascertained cost function.

7. The system as recited in claim 6, wherein the training unit is configured to apply a pruning method and/or a quantization method during training of the artificial neural network.

8. The system as recited in claim 6, wherein the at least one specification regarding available resources contains one or more of a specification regarding available memory capacities or a specification regarding an available bandwidth or a specification regarding a possible number of bit operations.

9. The system as recited in claim 6, wherein the training data contain sensor data.

10. A system for classifying image data, wherein the system is configured to classify image data using an artificial neural network that is trained to classify image data, and wherein the artificial neural network has been trained using a system for training an artificial neural network including:
a providing unit configured to provide training data for training the artificial neural network;
a detection unit configured to detect at least one specification regarding available resources;
an ascertaining unit configured to ascertain a cost function that, in addition to an actual learning task, also takes into account the at least one specification regarding available resources; and
a training unit configured to train the artificial neural network based on the provided training data using the ascertained cost function.

11. A non-transitory computer-readable date carrier on which is stored a computer program including program code for training an artificial neural network, the program code, when executed by a a computer, causing the computer to perform the following steps:
providing training data for training the artificial neural network;
detecting at least one specification regarding available resources;
ascertaining a cost function that, in addition to an actual learning task, also takes into account the at least one specification regarding available resources; and
training the artificial neural network based on the provided training data using the ascertained cost function.
